(19) United States
(12) Patent Application Publication
(10) Pub. No.: US 2009/0168150 A1
(43) Pub. Date: Jul. 2, 2009

(54) ELECTRO-OPTIC GAIN CERAMIC AND LOSSLESS DEVICES

(76) Inventors: Kewen Kevin Li, Andover, MA (US); Hua Jiang, Sharon, MA (US); Yingyin Kevin Zou, Lexington, MA (US)

Correspondence Address: Yingyin Kevin Zou, 4 Fairbanks Rd, Lexington, MA, 02421, US

(21) Appl. No.: 12/365,150

(22) Filed: Feb. 3, 2009

Related U.S. Application Data
(62) Division of application No. 11/528,166, filed on Sep. 27, 2006, now abandoned.
(60) Provisional application No. 60/812,263, filed on Jun. 9, 2006.

(51) Int. Cl. H01S 3/00

(52) U.S. Cl. 359/341.5

(57) ABSTRACT

The present invention provides a neodymium doped, transparent electro-optic gain ceramic material consisting lead, zirconium, titanium and lanthanum. The electro-optic gain ceramic material either has a linear electro-optic coefficient or a quadratic electro-optic coefficient, which is greater than about 0.3×10⁻¹⁶ m²/V² for the latter, a propagation loss of less than about 0.3 dB/mm, and an optical gain of great than 2 dB/mm at a wavelength of about 1064 nm while optically pumped by a 2 watts diode laser at a wavelength of 802 nm at 20° C. The present invention also provides electro-optic devices including a neodymium doped, transparent electro-optic gain ceramic material consisting lead, zirconium, titanium and lanthanum. The present invention also provides lossless optical devices and amplifiers with an operating wavelength in the range of 1040 nm to 1100 nm while optically pumped at a wavelength in the range of 794 nm to 810 nm. The materials and devices of the present invention are useful in light intensity, phase and polarization control at a wavelength of about 1060 nm.

### CROSS REFERENCE TO RELATED APPLICATION

This is a division of application Ser. No. 11/528,166, filed Sep. 27, 2006, which claims the benefit of Provisional Patent Application Ser. No. 60/812,263 filed Jun. 9, 2006, the entire teachings of all of which are incorporated herein by this reference.

### STATEMENT OF GOVERNMENTAL INTEREST

This invention was made with Government supports under grant no. DMI-0450547 awarded by National Science Foundation. The government has certain rights in this invention.

### BACKGROUND OF THE INVENTION

1. Technical Field

The present invention relates to materials and devices with optical gains, and more particular an electro-optic material with high transparency and high optical gain and electro-optic activity and devices constructed using such materials.

2. Technical Background

Since neodymium (Nd) doped yttrium aluminate garnet, Nd:Y₃Al₅O₁₂, or Nd:YAG, laser material was discovered, progress in the fabrication technique (the Czochralski, or CZ method) has rapidly improved its optical quality. In recent years, lasers have been applied with remarkable success to various fields such as laser radar, material processing, and others. Only single crystals created by the CZ method, however, have been used as laser materials. It is extremely difficult to dope more than 1 at. % of Nd homogeneously as a luminescence element in a YAG single crystal, because the effective segregation coefficient of elemental Nd in the host material (the YAG single crystal) is 0.2. Nd:YAG material's producing cost and small crystal size limit the technical advance of the solid-state laser. Thus, new solid-state materials with high efficiencies and at low costs will have great impact on high power laser development.

Attempts to synthesize solid-state laser material from polycrystalline YAG ceramics have been reported, such as by A. Ikesue, et al. (“Fabrication and optical characteristics of polycrystalline Nd:YAG ceramics for solid-state laser,” Technical Digest of CLEO/Pacific Rim'95., Jul. 10˜14, 1995, p. 3.) However, synthesizing Nd:YAG laser material of polycrystalline ceramics is technically very difficult. Polycrystalline, transparent Nd:YAG ceramics were fabricated by a solid-state reaction method using high-purity Al₂O₃ and Y₂O₃ powders, because optical materials for a solid-state laser must meet extremely severe requirements. Transparent YAGs are traditionally fabricated by a two-step process: hot pressing (HP) followed by hot isostatic pressing (HIP) at 1600-1800° C. This rendered the YAG fabrication process inefficient and high-cost.

Nd:YAG laser can be worked in either continues wave (CW) or pulsed mode. To have a high peak power, pulsed mode is preferred. One common practice to generate high peak power laser pulses is a Q-switched Nd:YAG laser. Active Q-switched laser using an acoustic-optic (AO) or electro-optic (EO) Q-switch exhibits much stable performance. However, laser materials themselves lack the capability of active Q-switching.

Lead lanthanum zirconate titanate (PLZT) is a transparent ferroelectric ceramic with a perovskite crystal structure and a variety of interesting properties that make it suitable for active electro-optical devices such as optical modulators and Q-switches. Comparing to the YAG ceramics, ferroelectric PLZT ceramics are not only highly transparent in a broad wavelength range from visible to mid-wave infrared but also among the highest electro-optic coefficient materials.

Recently, there are some efforts on rare earth doped electro-optic PLZT materials. It is taught that the neodymium (Nd) doped PLZT has good transparency, good absorption and photoluminescence. However, it has not been taught a Nd doped PLZT with large electro-optic phase retardation and large optical gain and how to build a device to utilize the Nd doped PLZT ceramics.

Any material has optical losses therefore a material can be used as lossless device is needed.

### SUMMARY OF THE INVENTION

One aspect of the present invention relates to a neodymium doped, transparent electro-optic gain ceramic material consisting lead, zirconium, titanium, and lanthanum.

Another aspect of the present invention relates a neodymium doped, transparent electro-optic gain ceramic material consisting lead, zirconium, titanium and lanthanum, wherein the electro-optic gain ceramic material has either a linear or a quadratic electro-optic coefficient, which could be greater than about 0.3×10⁻¹⁶ m²/V² for the latter, a propagation loss of less than about 0.3 dB/mm, and an optical gain of great than 2 dB/mm at a wavelength of about 1064 nm while optically pumped by a 2 watts diode laser at a wavelength of 802 nm at 20° C.

Another aspect of the present invention relates a neodymium doped, transparent electro-optic gain ceramic material consisting lead, zirconium, titanium, and lanthanum, wherein the electro-optic gain material has either a linear or a quadratic electro-optic coefficient, which could be greater than about 0.3×10⁻¹⁶ m²/V² for the latter, a propagation loss of less than about 0.3 dB/mm, and an optical gain of great than 2 dB/mm at a wavelength of about 1064 nm while optically pumped by a 2 watts diode laser at a wavelength of 802 nm at 20° C., and wherein the electro-optic ceramic material has the formula

Pb_{1-y-z}Nd_{y}La_{z} (ZrₓTi₁₋ₓ)_{1-y/4-z/4}O₃, wherein x is between about 0.05 and about 0.95, y is between about 0.001 and about 0.05, and z is between about 0 and about 0.15. One especially preferred electro-optic gain ceramic materials of the present invention, x is between about 0.55 and about 0.85, y is between about 0.001 and about 0.03, and z is between about 0.07 and 0.12.

Another aspect of the invention is an electro-optic device including a neodymium doped, lead, zirconium, titanium, and lanthanum-based electro-optic gain ceramic material.

Yet another aspect of the invention is a lossless electro-optic device or an optical amplifier including a neodymium doped lead, zirconium, titanium, and lanthanum-based electro-optic gain ceramic.

The materials and devices of the present invention result in a number of advantages over conventional materials and devices. The materials of the present invention have high transparency over a wide wavelength range. The materials have significant quadratic electro-optic coefficients and high optical gains make it suitable for both electro-optic device and laser applications. Additional features and advantages of the invention will be set forth in the detailed description which follows, and in part will be readily apparent to those skilled in the art from the description or recognized by practicing the invention as described in the written description and claims hereof, as well as in the appended drawings.

It is to be understood that both the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification. The drawings are not necessarily to scale. The drawings illustrate one or more embodiment(s) of the invention, and together with the description serve to explain the principles and operation of the invention.

### BRIEF DESCRIPTION OF THE DRAWINGS

FIG. 1 is a schematic depiction of a general perovskite structure;

FIG. 2 is an x-ray diffraction spectrum of two electro-optic gain ceramic compositions of an embodiment of the present invention;

FIG. 3 is a transmission spectrum of an electro-optic gain ceramic material of one embodiment of the present invention;

FIG. 4 is a schematic diagram of an experimental setup used to measure electro-optic coefficients;

FIG. 5 is electro-optic phase retardation measurement results of the electro-optic gain ceramic materials of the present invention;

FIG. 6 is an absorption spectrum of two electro-optic gain ceramic compositions of an embodiment of the present invention;

FIG. 7 is a photoluminescence spectrum of two electro-optic gain ceramic compositions of an embodiment of the present invention;

FIG. 8 is a schematic diagram of an experimental setup used to measure optical gain;

FIG. 9 is optical gain measurement results of the electro-optic gain ceramic materials of the present invention;

FIG. 10 is an embodiment of the present invention of a lossless electro-optic device using electro-optic gain ceramic materials.

### DETAILED DESCRIPTION OF THE PREFERRED EMBODIMENTS

The present invention provides an electro-optic gain ceramic material with high transparency, high quadratic electro-optic coefficients, and high optical gain. The electro-optic gain ceramic materials of the present invention are rare earth neodymium ion (Nd³⁺) doped lanthanum-modified lead zirconate titanate (PLZT) ceramics having either a linear or a quadratic electro-optic coefficient, which could be greater than about 0.3×10⁻¹⁶ m²/V² for the latter, a propagation loss of less than about 0.14 dB/mm, and an optical gain of great than 2 dB/mm at a wavelength of about 1064 nm while optically pumped by a 2 watts diode laser at a wavelength of 802 nm at 20° C. The electro-optic gain ceramic materials of the present invention are useful in the fabrication of electro-optic devices such as optical amplifiers and ceramic lasers. It is also useful for various electro-optic devices such as modulators, switches, polarization controllers, and variable optical attenuators. These devices could be a optically lossless device under appropriate optical pumping.

Electro-optic materials are materials that change their birefringence in the presence of an electric field. The utility of an electro-optic material in an electro-optic device depends, in large part, on the magnitude of its electro-optic coefficients. The birefringence Δn of an electro-optic material in the presence of an electric field can be described by the equation

$$Δ n = Δ {n}_{0} + \frac{{n}^{3}}{2} ( γ \cdot E + R \cdot {E}^{2} )$$

where Δn₀ is the birefringence of the material in the absence of an electric field, n is the ordinary refractive index of the material, E is the magnitude of the applied electric field, γ is the linear electro-optic coefficient, and R is the quadratic electro-optic coefficient. As the electro-optic gain ceramic materials of the present invention, a Nd³⁺ doped PLZT (Nd:PLZT) electro-optic gain ceramic materials may exhibit either linear electro-optic coefficient γ after electrical poling or quadratic electro-optic coefficients R, depending on the materials composition ratio. One example of the present invention is the Nd:PLZT electro-optic gain ceramic material is isotropic under no external electric field, Δn₀ and γ are essentially zero, making the electro-optic activity proportional to the quadratic electro-optic coefficient. The Nd:PLZT electro-optic gain ceramic materials described herein as the example have quadratic electro-optic coefficients R greater than about 0.3×10⁻¹⁶ m²/V² at 20° C. and at a wavelength of 1064 nm.

While electro-optic activity is important, a material with high electro-optic activity will be rendered useless if it is not sufficiently transparent at the wavelength of interest. Transparency at wavelengths ranging from visible to infrared is an important feature of the electro-optic gain ceramic materials of the present invention. As will be described more fully below, the electro-optic ceramic gain materials of the present invention can be formed by the skilled artisan to be very dense and relatively free of scattering voids and undesired impurity phases. The electro-optic gain ceramic materials of the present invention have propagation losses of less than about 0.3 dB/mm, and preferably less than about 0.14 dB/mm.

In the present invention, the electro-optic gain ceramic material includes lead, zirconium, titanium, lanthanum and neodymium. The relative amounts of individual atomic species may be described by a cation fraction. As used herein, a cation is any atomic species bearing a positive formal charge. For example, though the titanium atom is part of the polyatomic titanium anion (TiO₃²⁻) in the present compositions, the titanium atom itself has a +4 formal charge, and is thus considered herein to be a cation. The cation fraction of a particular atomic species is the ratio of the number of atoms of the particular atomic species to the total number of cationic atoms.

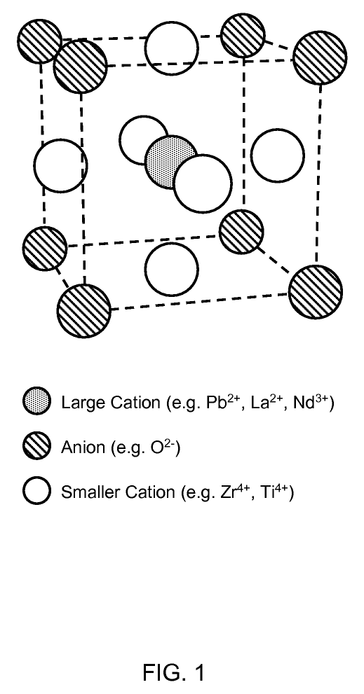

In the electro-optic gain ceramic materials of the present invention, each crystalline grain desirably has a perovskite structure. The perovskite structure, shown in FIG. 1, has a unit cell in which the large cations (e.g. Pb²⁺, La³⁺, Nd³⁺) and the anions (e.g. O²⁻) form a cubic close packed (ccp) array with the smaller cations (e.g. Zr⁴⁺, Ti⁴⁺) occupying those octahedral holes formed exclusively by anions.

Preferred electro-optic gain ceramics of the present invention may be described by the general formula

Pb_{1-y-z}Nd_{y}La_{z}(ZrₓTi₁₋ₓ)_{1-y/4-z/4}O₃

wherein x is between about 0.05 and about 0.95, y is between about 0.001 and about 0.05, and z is between about 0 and about 0.15. In especially preferred electro-optic gain ceramic materials of the present invention, x is between about 0.55 and about 0.85, y is between about 0.001 and about 0.03, and z is between about 0.07 and 0.12.

The electro-optic gain ceramic materials of the present invention may be made by methods familiar to the skilled artisan. A wide variety of inorganic compounds may be used as the starting materials. For example, oxides, hydroxides, carbonates, sulfates, acetates or alkoxides of the desired metals may be used to form the ceramics of the present invention. In general, an opaque powder having the desired ceramic stoichiometry is first prepared and dried. For example, the mixed oxide method has been used to fabricate powders of the materials of the present invention, as described below in Example 1. Other methods, such as chemical co-precipitation and other more advanced techniques, may be used to prepare the powder. Before being densified, the powder may optionally be formed into an opaque powder preform by, for example, cold pressing.

The opaque powder or powder preform may then densified by methods familiar to the skilled artisan to form the ceramic materials of the present invention. For example, a powder preform may be hot-pressed to form a dense, transparent, perovskite-structured ceramic as described below in Example 1. Important processing parameters such as hot-pressing temperature, applied pressure, ambient conditions and processing time may be determined by the skilled artisan. Other densification techniques, such as vacuum sintering, isostatic pressing, hot isostatic pressing, or other pressing or sintering methods may be used by the skilled artisan to form the transparent ceramics of the present invention.

The electro-optic gain ceramic materials of the present invention are useful in the construction of electro-optic devices. Another aspect of the invention is an electro-optic device including a neodymium doped lead, zirconium, titanium and lanthanum-based electro-optic gain ceramic material. The electro-optic device may work at a wavelength in the range of 500 nm to 2600 nm. The electro-optic gain material used in the device may have a quadratic electro-optic coefficient of greater than about 0.3×10⁻¹⁶ m²/V², a propagation loss of less than about 0.3 dB/mm, and an optical gain of great than 2 dB/mm at 20° C. at a wavelength of 1064 nm. The electro-optic ceramic material used in the device may have the compositions described hereinabove. The electro-optic gain ceramic material has the general formula Pb_{1-y-z}Nd_{y}La_{z}(ZrₓTi₁₋ₓ)_{1-y/4-z/4}O₃ wherein x is between about 0.05 and about 0.95, y is between about 0.001 and about 0.05, and z is between about 0 and about 0.15. In especially preferred electro-optic gain ceramic materials of the present invention, x is between about 0.55 and about 0.85, y is between about 0.001 and about 0.03, and z is between about 0.07 and 0.12.

An electro-optic device of the present invention may be, for example, an intensity modulator, a phase modulator, a switch, a phase retarder, a polarization controller, or a variable optical attenuator. Exemplary electro-optic devices that may be constructed using the electro-optic gain ceramic material of the present invention are described in U.S. Pat. Nos. 6,137,619, 6,330,097, 6,404,537, 6,522,456, and 6,700,694. Electro-optic devices of the present invention may be constructed in accordance with known techniques for making devices based on other electro-optic materials, such as PLZT.

Yet another aspect of the present invention relates to an optical lossless device or a light amplifier using a neodymium doped electro-optic gain ceramic material including lead, zirconium, titanium, and lanthanum. The operating wavelength is in the range of 1040 nm to 1100 nm.

The invention will be further clarified by the following non-limiting examples which are intended to be exemplary of the invention.

### Example 1

A electro-optic gain ceramic material, 0.5% Nd:PLZT having the formula

Pb_{0.895}Nd_{0.005}La_{0.10}(Zr_{0.65}Ti_{0.35}]_{0.9738}O₃

The 0.5 at. % Nd³⁺ doped PLZT 10/65/35, or 0.5% Nd:PLZT, consisted of 65 mol % lead zirconate plus 35 mol % lead titanate and 10 mol % lanthanum in the form of La₂O₃, i.e. 10/65/35, to which 0.5 mol % Nd cations had been added in the form of Nd₂O₃. The origins of the components were PbO, La₂O₃, ZrO₂, TiO₂, and Nd₂O₃, respectively. Raw materials (oxide powders) were weighed and mixed according to batch formulation. It was followed by a 900° C., 1-hour calcination reaction. The calcined powders were then ball-milled to yield the final powder of fine particle size, which is then ready to be hot-pressed. Prepared powders were cold-pressed into a preform with a diameter of 1.25-4 inches under a pressure of 2,500 psi. During the hot press stage, a pressure of 1,000-3,000 psi was applied through two alumina rods in a temperature-controlled furnace. The firing was carried out at 1100-1300° C. for up to 20 hrs under an oxygen atmosphere. The fired slug was then cut and polished into wafers for various analyses. Different percentage of Nd³⁺ doping may be made by the skilled artisan. 0% to 3% Nd³⁺ doped PLZT had been made.

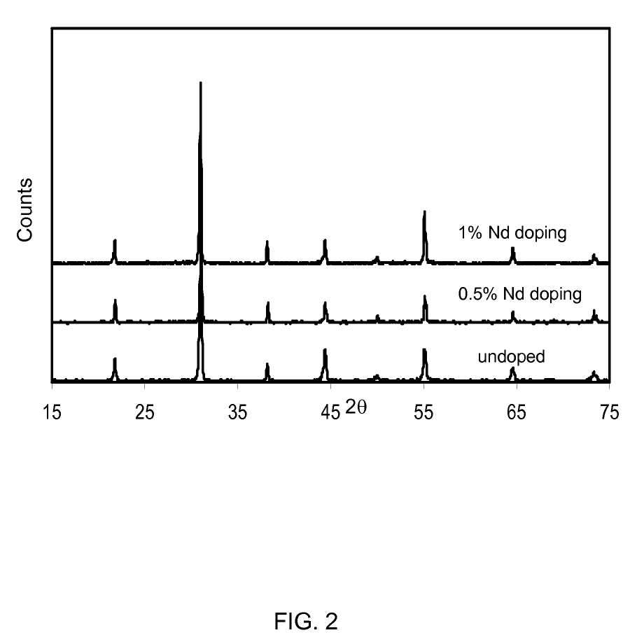

X-ray diffraction patterns are measured for un-doped PLZT, 0.5% Nd:PLZT, and 1% Nd:PLZT, respectively, using a Rigaku diffractometer with CuK_{α} radiation in the 2θ range of 15° to 75° as shown in FIG. 2. The X-ray diffraction patterns show that all these hot-pressed ceramics have almost cubic symmetries and that the patterns can be indexed as cubic phases, which display a predominantly single phase material with pseudo-cubic perovskite structure. There is no trace of secondary phase, which usually can be addressed to oxide compounds of the raw materials segregated at the grain boundaries. FIG. 2 also shows that even though the Nd³⁺ doping concentration is increased from 0 to 0.5% to 1%, the structure is still not affected.

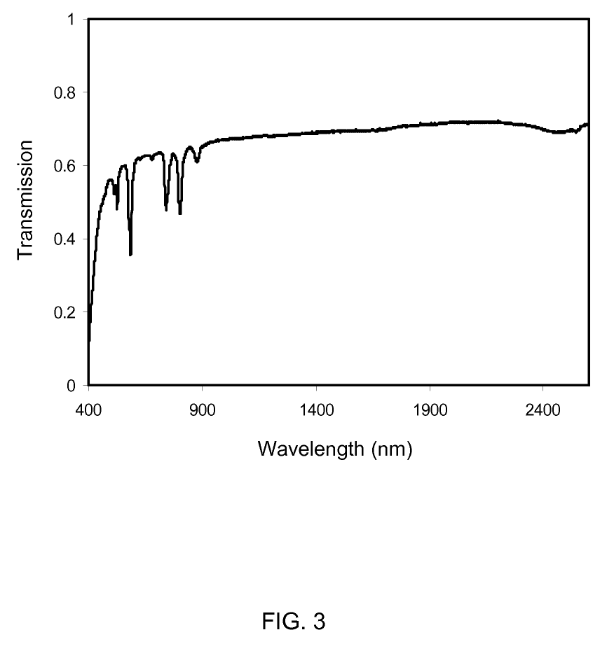

The transmission of both the 0.5% Nd:PLZT and 1% Nd:PLZT samples with a thickness of 2 mm are found to be very similar and is around 70% in the wavelength range from 500 nm to 2600 nm as shown in FIG. 3. The materials have about 100 percent transmittance after correction for reflection losses. The excellent transmission of the Nd:PLZT in the infrared range makes it desirable for making devices and lasers at wavelengths of about 1064 nm and 920 nm.

### Example 2

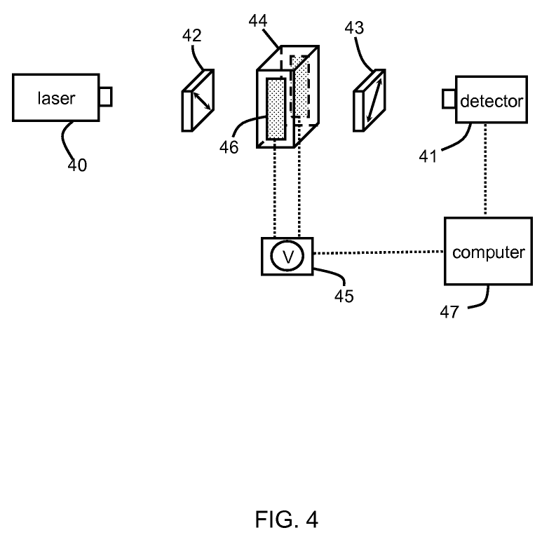

The quadratic electro-optic constant of the 0.5% Nd:PLZT and 1.0% Nd:PLZT material of Example 1 was measured using the experimental setup shown in FIG. 4. Light from a laser 40 passed through an input polarizer 42. Electrodes 46 are deposited on opposite faces of a polished sample 44 in order to allow the application of an electric field through the sample by a power source 45. The sample is placed in the light path with the direction of the applied electric field perpendicular to the direction of the light path and at a 45° angle to the polarization of the beam. After emerging from the sample the light is passed through an output polarizer 43 having its polarization axis set to be perpendicular to the polarization axis of the input polarizer 42. Light emerging from the output polarizer 43 is detected by a photodetector 41. A computer 47 is used to control the applied electric field, and to collect the measurement data. When the system is integrated with a function generator and an oscilloscope (not shown) by the skilled artisan, it may be used for measurement of response speed.

When no electric field is applied, the sample 44 has no effect on the polarization of the beam; therefore, no light makes it to the detector due to the action of the crossed polarizers 42 and 43. As the applied electric field increases, the sample becomes birefringent due to the electro-optic effect, and rotates the polarization of the beam. At a voltage V_{π}, the polarization of the beam is rotated by the sample enough to be parallel to the polarization axis of the second polarizer 43, maximizing the intensity of the detected signal. Assuming the material's native birefringence (Δn₀) and linear electro-optic coefficient γ are zero, the quadratic electro-optic coefficient R may be calculated from the equation

$$R = \frac{{d}^{2} λ}{{V}_{π}^{2} {n}^{3} L}$$

where d is the distance between electrodes (i.e. the width of the sample), n is the refractive index of the sample at the wavelength λ, and L is the path length of the beam in the sample.

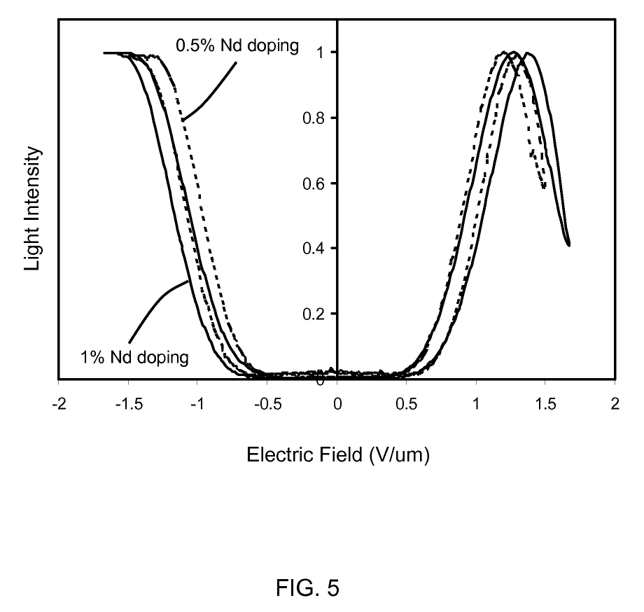

Samples were cut from a 1.44 mm thick wafer polished on both sides. The samples had a width of 0.5 mm and a height of 2.5 mm. The parallel side surfaces of each sample were polished, plasma etched for 3 min, then coated with Pt/Au electrodes (250 Å/2500 Å). The electric field induced phase retardation of 0.5% Nd:PLZT and 1% Nd:PLZT was illustrated in FIG. 5. Quadratic EO coefficients of 0.30×10⁻¹⁶ m²/V² and 0.34×10⁻¹⁶ m²/V² were obtained for the 1.0 mol % and 0.5 mol % Nd doped PLZT samples, respectively.

### Example 3

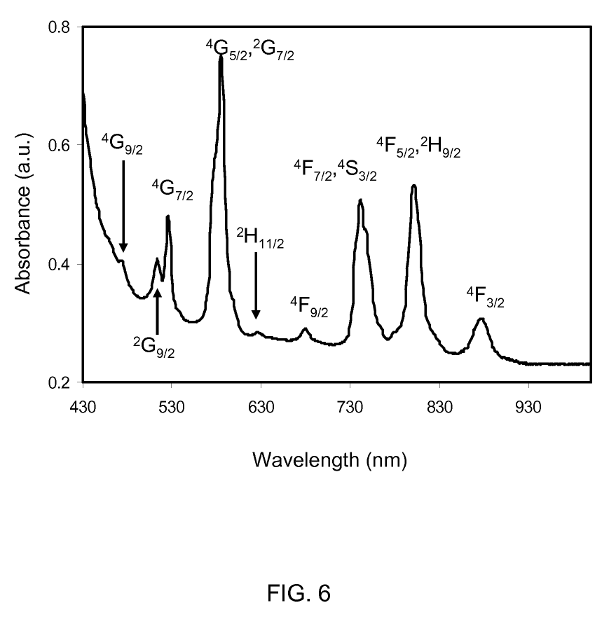

The room temperature ground state absorbance of 1% Nd³⁺ doped PLZT from Example 1 was measured in spectral region of 400˜1000 nm by a UV-VIS-NIR spectrophotometer (Perkin-Elmer, Lamda 9). A number of absorption lines are observed and assigned as transitions from the Nd³⁺ ground state ⁴I_{9/2} to different excited states, namely ⁴F_{3/2} (879 nm), ⁴F_{5/2} (803 nm), ²H_{9/2} (803 nm), ⁴F_{7/2} (742 nm), ⁴S_{3/2} (742 nm), ⁴F_{9/2} (681 nm), ²H_{11/2} (629 nm), ⁴G_{5/2} (585 nm), ²G_{7/2} (585 nm), ⁴G_{7/2} (526 nm), ²G_{9/2} (514 nm), and ⁴G_{9/2} (475 nm), as shown in FIG. 6. The full width at half maximum (FWHW) of the peak wavelength that can be used for optical pumping near 803 nm in Nd:PLZT was 16 nm, about three times wider than that in crystalline Nd:YVO₄ (5 nm) at 808 nm, due to the polycrystalline nature of the PLZT family.

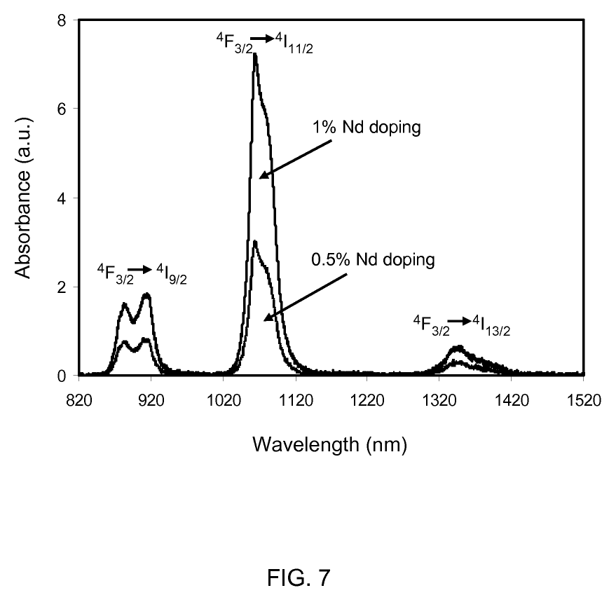

The room temperature photoluminescence (PL) was measured using a CW diode laser as the excitation source (LDI 820). The PL was obtained with excitation of levels ²H_{9/2} and ⁴F_{5/2} at 798 nm because the absorption coefficient at this wavelength was at least three times higher than that corresponding to ⁴I_{9/2}→⁴F_{3/2} transition at 870 nm, as shown in FIG. 7. An appropriate long-pass filter (Corion filters, LL-850-F) was used between the sample and the monochorometer entrance to prevent scattering of the pump laser light from getting into the monochorometer (McPherson, model 78A-3). Photoluminescence from the sample was modulated with a chopper at a frequency of 250 Hz before entering the entrance slit (slit width is 600 μm). A PbS detector was used at the exit of the monochromator to convert the photoluminescence signal to electrical. Three-emission peaks at 915, 1066 and 1347 nm were observed that corresponded to the ⁴F_{3/2}→⁴I_{9/2}, ⁴F_{3/2}→⁴I_{11/2} and ⁴F_{3/2}→⁴I_{13/2} transitions, respectively.

### Example 4

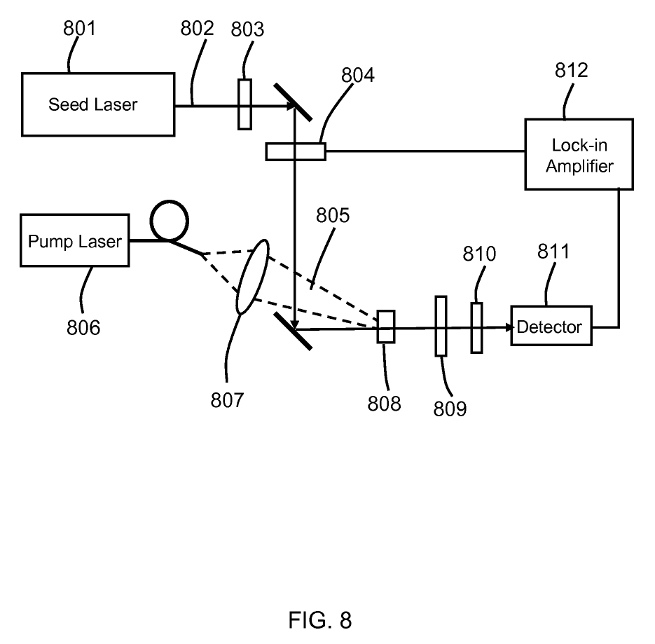

A configuration resembling to a traditional two-wave mixing geometry was chosen in our single-pass gain measurements, as shown on FIG. 8. A solid-state Nd:YAG laser 801 (Coherent, DPSS 1064) was used as a seed laser source in which the center wavelength is 1064.4 nm and the FWHM is 0.4 nm. The seed laser beam 802 was collimated by a two-lens set (not shown here) and attenuated by a neutral density filter 803, and then modulated by a chopper 804 to be detected by a detector 811 and a lock-in amplifier 812. A fiber-pigtailed and TE-cooled high-power laser diode 806 (Apollo Instruments, S-30-806-6) with 802-nm center wavelength, followed by a focus lens 807 to control the size of pump beam 805 for mode matching, was used to pump a Nd:PLZT sample 809. A pinhole 809 and a long pass (>1 um) filter 810 were used to block the pumping power to enter into the detector 811. Observable single-pass gains were obtained.

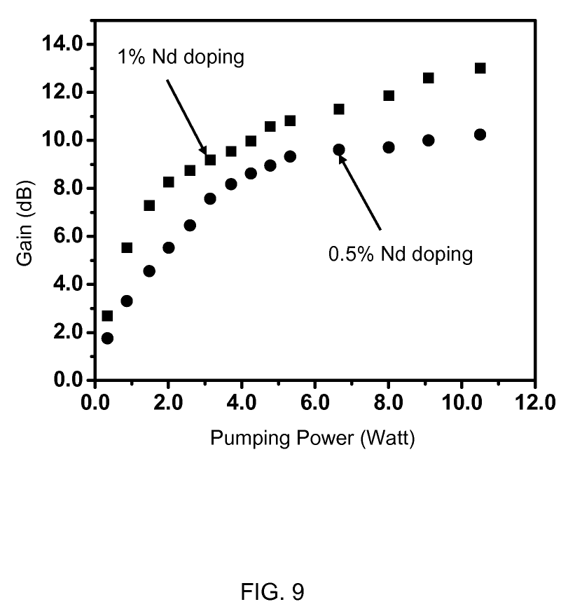

Very high single-pass gains have been obtained in both the 1.0% Nd:PLZT and 0.5% Nd:PLZT samples from Example 1. For a fixed seed power 50 nW with 1.0 mm diameter of the seed laser beam, the gains as a function of pumping power for the samples were shown in FIG. 9. An optical gain of great than 5 dB was achieved with a material about 2 millimeter long at a wavelength of about 1064 nm while optically pumped by a 2 watts diode laser at a wavelength of 802 nm at 20° C., which is equivalent to 2 dB/mm. In 1.0% Nd:PLZT, as high as 13.0 dB single-pass gain was obtained for small seed signal at higher pumping side (11.0 W), nearly doubled the values by percentage obtained from 0.5% Nd:PLZT, suggesting negligible quenching effect. As indicated in FIG. 6 and FIG. 7, both the absorption spectrum and photoluminescence spectrum of the Nd:PLZT are very broad, a pumping diode with a wavelength in the range of 794 nm to 810 nm can be used and an optical signal with a wavelength in the range of 1040 nm to 1100 nm can be amplified. The optical propagation loss is in the ranged of 0.3 dB/mm to 0.14 dB/mm.

### Example 5

Electro-optic device can be configured which includes a neodymium doped, lead, zirconium, titanium and lanthanum-based electro-optic gain ceramic material. The Nd:PLZT is transparent from 500 nm to 2600 nm. Various electro-optic devices can be constructed using this material. Some examples are a light modulator, a light polarization transformer/controller, an optical filter, an optical switches and an optical retarder.

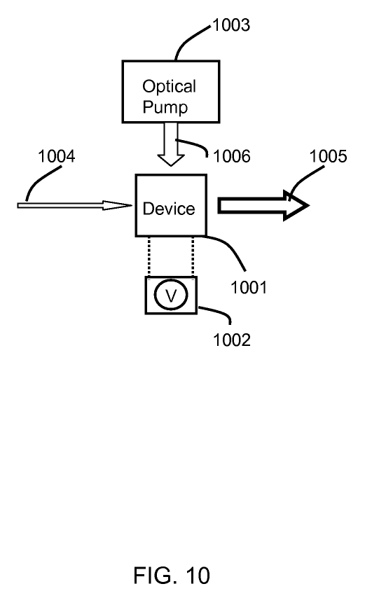

Since the optical gain is much greater than the loss, a lossless electro-optic device or an optical amplifier can be constructed. Illustrated in FIG. 10 is an embodiment of the invention of a lossless electro-optic device. An electro-optic device 1001 based on electro-optic gain ceramic material was controlled by a voltage control circuit 1002. It will manipulate the properties of the input light signal 1004 to form the output light signal 1005, which will result different optic devices, for example, an intensity modulator, a phase modulator, a switch, a phase retarder, a polarization controller, or a variable optical attenuator. The device is inherited with optical loss. By illuminate the electro-optic gain ceramic material with an optical pumping signal 1003, which can be a laser, a flash light or other optical mean, optical signal gain will occurred in device 1001 to compensate the optical loss of the device. Hence the lossless optical device can be achieved. When an optical gain is greater than the loss, optical signal amplification can be achieved.

The wavelength of the optical pumping source is in the range of 794 nm to 810 nm. The device is preferred working at a wavelength in the range of 1040 nm to 1100 nm, for both a lossless device and an optical amplifier.

It will be apparent to those skilled in the art that various modifications and variations can be made to the present invention without departing from the spirit and scope of the invention. Thus, it is intended that the present invention covers the modifications and variations of this invention provided they come within the scope of the appended claims and their equivalents.

What is claimed is:

1. An optical lossless device comprising
a transparent electro-optic gain ceramic material including
lead,
zirconium,
titanium,
lanthanum and
neodymium; and
an optical pumping source has a wavelength in the range of 794 nm to 810 nm;

2. The optical lossless device of claim 19 has a working wavelength in the range of 1040 nm to 1100 nm.

3. The optical lossless device of claim 1 wherein the transparent electro-optic gain ceramic material has a quadratic electro-optic coefficient of greater than about 0.3×10⁻¹⁶ m²/V², a propagation loss of less than about 0.3 dB/mm, and an optical gain of great than about 2 dB/mm at a wavelength of about 1064 nm while optically pumped by a 2 watts diode laser at a wavelength of about 802 nm at 20° C.

4. The optical lossless device of claim 1 wherein the transparent electro-optic gain ceramic material comprises the formula
Pb_{1-y-z}Nd_{y}La_{z}(ZrₓTi₁₋ₓ)_{1-y/4-z/4}O₃
wherein
x is between about 0.05 and about 0.95,
y is between about 0.001 and about 0.05, and
z is between about 0 and about 0.15.

5. The optical lossless device of claim 1 further comprising an electric control circuit wherein the properties of the input light signal is manipulated by a control voltage.
